(19) United States
(12) Patent Application Publication
(10) Pub. No.: US 2016/0263560 A1
(43) Pub. Date: Sep. 15, 2016

(54) CHROMIUM-FREE WATER-GAS SHIFT CATALYST AND PROCESS FOR MAKING THE SAME

(71) Applicant: pH Matter, LLC, Columbus, OH (US)

(72) Inventors: Christopher T. Holt, Bexley, OH (US); Paul H. Matter, Columbus, OH (US); Michael G. Beachy, Gahanna, OH (US)

(21) Appl. No.: 15/064,823

(22) Filed: Mar. 9, 2016

Related U.S. Application Data
(60) Provisional application No. 62/130,649, filed on Mar. 10, 2015.

(51) Int. Cl. B01J 23/745; B01J 23/72; C01B 3/16; B01J 37/04; B01J 37/08; B01J 21/02; B01J 35/10

(52) U.S. Cl. CPC B01J 23/745; B01J 21/02; B01J 23/72; B01J 35/1014; B01J 35/1019; B01J 37/04; B01J 37/088; C01B 3/16; C01B 2203/0283; C01B 2203/1047

(57) ABSTRACT

A chromium-free water-gas shift catalyst. In contrast to industry standard water-gas catalysts including chromium, a chromium-free water-gas shift catalyst is prepared using iron, boron, copper, aluminum and mixtures thereof. The improved catalyst provides enhanced thermal stability and avoidance of potentially dangerous chromium.

### CROSS-REFERENCE TO RELATED APPLICATIONS

This application claims the benefit of U.S. Provisional Patent Application 62/130,649 filed Mar. 10, 2015.

### STATEMENT REGARDING FEDERALLY SPONSORED RESEARCH OR DEVELOPMENT

This invention was made with government support under National Science Foundation Contract Number 1230320. The government may have certain rights in the invention.

### TECHNICAL FIELD

The present disclosure relates generally to a method for making a chromium-free water-gas shift catalyst.

### BACKGROUND OF THE INVENTION

The Water Gas Shift (WGS) reaction is an important step in the production of hydrogen from hydrocarbons and/or synthesis gas (syngas) streams. Conventional high temperature water-gas-shift catalysts are based on iron-chromium compositions. Chromium is used to slow the sintering of the iron-based active sites during operation. Currently there is an effort in industry to remove chromium-based water-gas shift catalysts due to the carcinogenic nature of hexavalent chromium. The disclosed invention relates to formulations of non-chromium catalysts. Specifically, we disclose several methods and non-chromium compositions for producing catalysts that exhibit stable water-gas shift performance. The catalyst described below would find use in a number of applications that require a water-gas-shift reactor. The details of the catalyst application and methods for producing these catalysts are described below.

The Water Gas Shift (WGS) reaction is an important step in the production of hydrogen from hydrocarbons. The forward WGS reaction, shown below, is thermodynamically favored at lower temperatures, with temperatures below 350° C. required for >99% conversion in typical stream compositions:

CO+H₂O [symbol] CO₂+H₂ (WGS Reaction)

Water-gas shift catalytic reactors can be found in numerous processes, such as steam methane reforming to hydrogen for ammonia synthesis, fuel reforming for fuel cells, and processes for conversion of coal, natural gas, or biomass to liquid fuels or hydrogen. Because of the lower reaction temperatures required by thermodynamics, catalysts are important to increase the rate of the WGS reaction. Since hydrogen is typically the desired product from the reaction, running the reaction at lower temperatures has a direct effect on improving process efficiencies.

There are numerous types of water-gas shift catalysts commercially available, including low temperature Cu-based catalysts, high temperature Fe/Cr catalysts, intermediate temperature non-pyrophoric precious metal catalysts, and Co/Mo-based sour gas shift catalysts. Table 1 outlines the process conditions for which the various types of WGS catalysts are typically used.

TABLE 1
Breakdown of operating ranges for commercial prior-art
WGS catalysts; data obtained from the DOE hydrogen from
coal program development plan and references.

| | | Low-/Medium- | High- | Sour |
|---|---|---|---|---|
| Performance | | temperature | temperature | Gas |
| Criteria | Units | Shift | Shift | Shift |
| Active metals | — | Cu/Zn | Fe/Cr | Co/Mo |
| Temperature | ° C. | 200-300 | 300-500 | 250-550 |
| Pressure | Psia | ~450 | 450-750 | ~1,100 |
| CO in feed | — | Low | Moderate | High |
| | | | to high | |
| Residual CO | % | 0.1-0.3 | 3.2-8 | 0.8-1.6 |
| Equilibrium | ° C. | 8-10 | 8-10 | 8-10 |
| approach | | | | |
| Min. H₂O/CO | Molar | 2.6 | 2.8 | 2.8 |
| ratio | | | | |
| Sulfur | Ppmv | <0.1 | <50 | >300 |
| Tolerance | | | | |
| Durability | Years | 3-5 | 5-7 | 2-7 |

### SUMMARY OF THE INVENTION

Various embodiments of a chromium-free water-gas catalyst including iron and boron are disclosed, some of which include copper, or aluminum and copper. The boron may reside substantially at the surface of the catalyst. In another series of embodiments, a chromium-free water-gas catalyst may include boron and copper, and these embodiments may further include aluminum or iron.

A process for producing a catalyst having improved thermal stability may include the steps of mixing a catalyst precursor and a source of boron to form a first mixture and then calcining the first mixture at a temperature equal to or greater that 300° C., or in other embodiments, at a temperature equal to or greater than 450° C. to form the catalyst. In some distinct embodiments, the boron precursor may include a source of boron including boric acid, boron oxide, alkali borate salts, boron nitride, alkali borohydrides, ammonia borane, organoboron compounds, iron boride, aluminum boride, copper boride, iron borate, aluminum borate, copper borate, and mixtures thereof. In some embodiments, the catalyst precursor may include a source of boron having a boron weight relative to the catalyst equal to or greater than 0.01% and equal to or less than 0.5%. The catalyst precursors, in various embodiments, may include a hydroxide of iron, a hydroxide of copper, a hydroxide of aluminum, mixtures thereof, a carbonate of iron, a carbonate of copper, a carbonate of aluminum, mixtures thereof, and mixtures of a hydroxide of iron, a hydroxide of copper, a hydroxide of aluminum, mixtures thereof, a carbonate of iron, a carbonate of copper, and a carbonate of aluminum, with a source of boron.

### BRIEF DESCRIPTION OF THE ILLUSTRATIONS

Without limiting the scope of the chromium-free water-gas shift catalyst as disclosed herein and referring now to the drawings and figures:

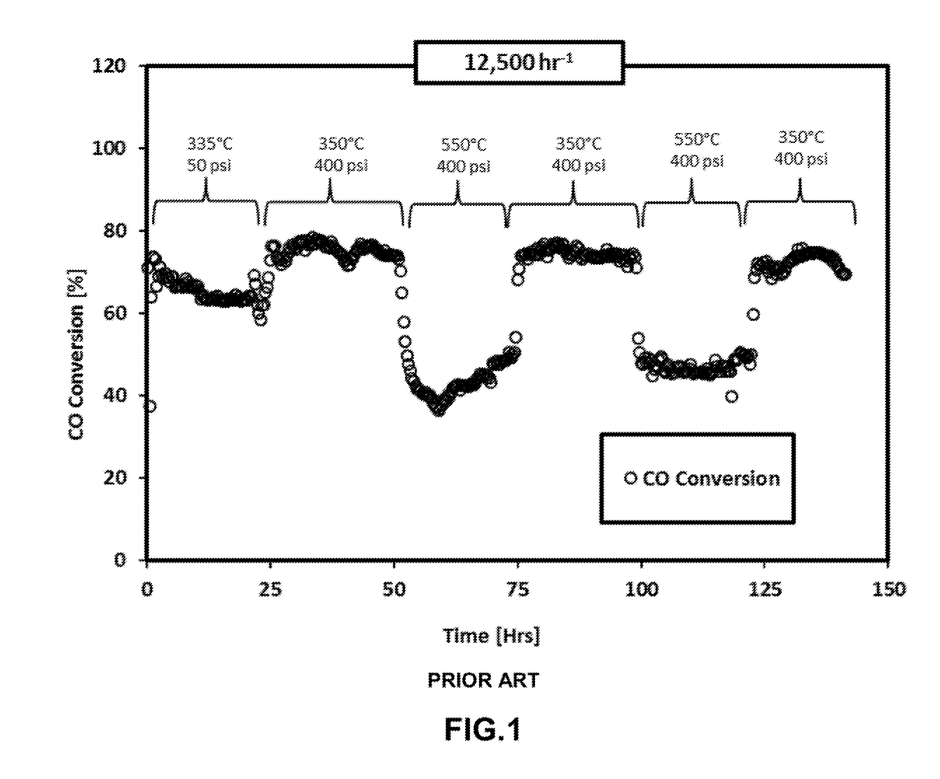

FIG. 1 shows the performance of commercial Fe/Cr catalyst undergoing thermal cycling at 400 psi, showing the typical industry standard for stability during this accelerated degradation test;

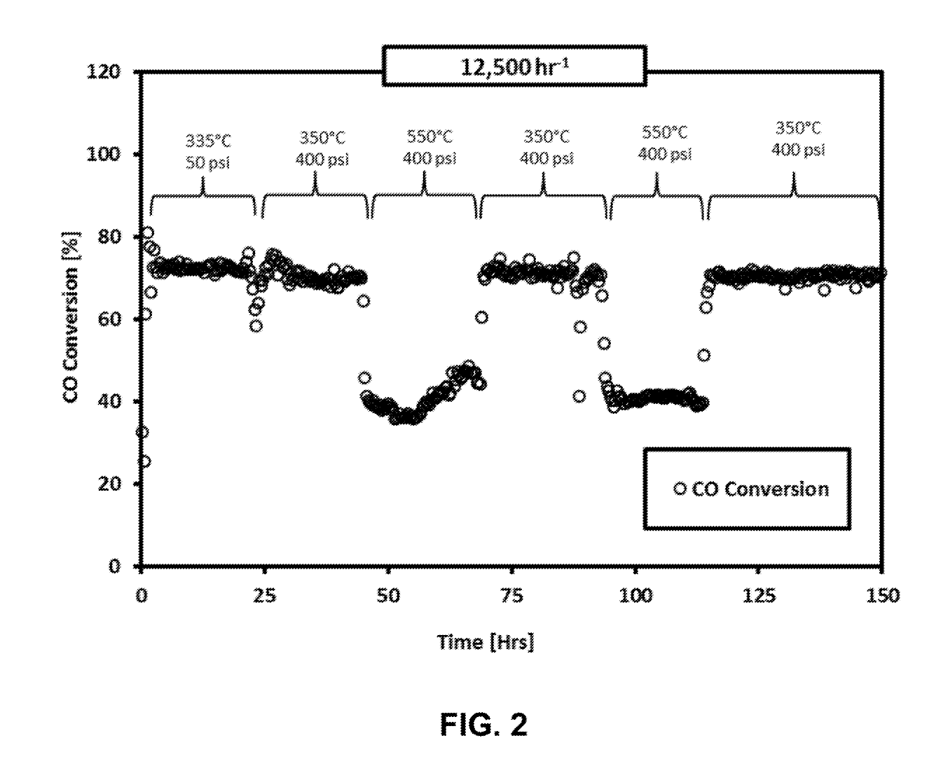

FIG. 2 shows the performance of non-chromium boron-doped catalyst sample Fe₂O₃—Al_{0.40}Cu_{0.10}B_{0.10}Oₓ (calcined at 700° C.) undergoing thermal cycling at 400 psi, showing excellent catalytic durability;

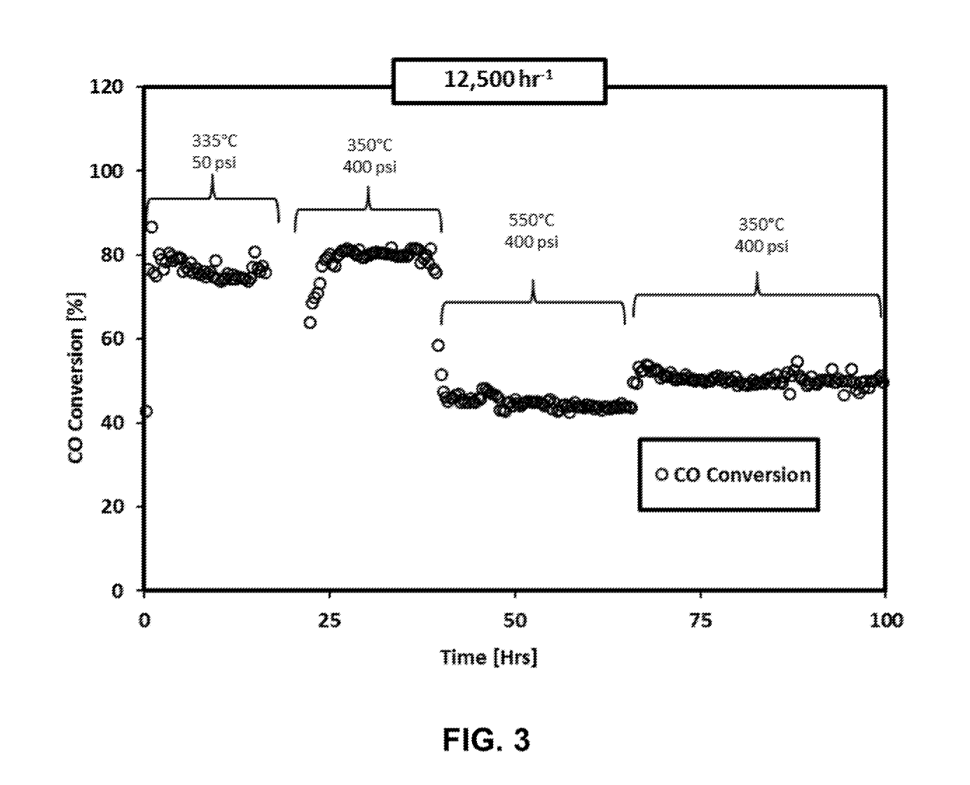

FIG. 3 shows the performance of non-chromium catalyst sample Fe₂O₃—Al_{0.40}Cu_{0.10}Oₓ (calcined at 700° C.) undergoing thermal cycling at 400 psi, showing poor durability; and

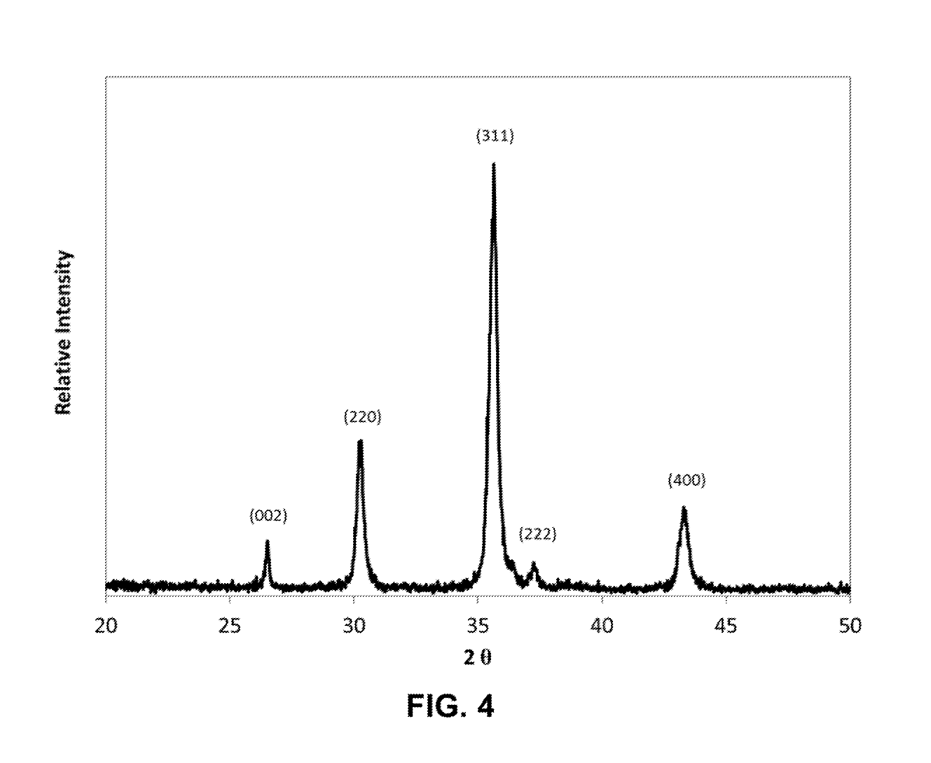

FIG. 4 shows post-testing XRD analysis showing a predominantly magnetite phase for Fe₂O₃—Al_{0.40}Cu_{0.10}B_{0.10}Oₓ (calcined at 700° C.).

These illustrations are provided to assist in the understanding of the exemplary embodiments of a chromium-free water-gas shift catalyst formulation and method of making the same, as described in more detail below, and should not be construed as unduly limiting the specification. In particular, the relative spacing, positioning, sizing and dimensions of the various elements illustrated in the drawings may not be drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION OF THE INVENTION

### EXAMPLES

A number of compositions were prepared and examined for WGS performance, as listed in Table 2 for testing at 100 psi and Table 3 for testing at 400 psi. In these catalysts, promoters such as copper and surface area stabilizers such as boron and/or alumina were discovered to boost the surface area and/or activity, with initial WGS performance greater than commercial iron-chromium high temperature WGS catalysts. To prepare the iron-based catalysts, a co-precipitation method was used. Metal nitrate salts were dissolved in distilled water, for example Fe (III) nitrate nonahydrate (80-90%), Al (III) nitrate nonahydrate (8-15%), Cu(II) nitrate hydrate-2.5-H₂O (2-5%), with a proportion of boron in the optimal range of 0.5 to 2 wt %, from preferably either a boric acid or sodium borate precursor. This acidic salt solution was subsequently added to a pre-heated (70° C.) base solution of preferably NaOH, KOH and/or NH₄OH with a molar range of 0.1 to 1 molar examined (excess base is used). After precipitation, the precipitate is aged for a given time period in the mother liquor, preferably 2 to 72 hours, then the solid precipitate is washed multiple times in distilled water to remove most of the dissolved ions, dried at 70° C., and subsequently calcined to form the catalyst. The compositions listed in Tables 2 and 3 are the target compositions (based on the precursor ratios used), not the measured compositions. In general, the actual boron concentration in the catalyst is thought to be lower than the target for the co-precipitation procedure because not all of the boron precipitates. For the incipient wetness (IW) procedure the boron should all remain in the catalyst because the precursor is not washed after boron addition.

All samples were tested in 8% CO, 5% CO₂, 35% H₂, 15% N₂, and 37% H₂O (by mole) at a space velocity of 12,500 hr⁻¹. Catalysts were pressed into pellets, then granulated and sieved between 15 and 80 mesh size before loading into a stainless steel micro-reactor. Approximately 0.5 grams of catalyst was used in each test. In each test, after reduction for 16 hours at 335° C. and 50 psi, the pressure was increased to the reported pressure (either 100 psi or 400 psi) and temperature was raised to 350° C. for 24 hours, followed by 24 hour cycles between 550° C. and 350° C. to accelerate degradation. In testing at 100 psi, the addition of aluminum and/or boron had a positive effect on CO conversion before and after thermal cycling (see Table 2). The best sample, Fe₂O₃—Al_{0.4}Cu_{0.10}B_{0.10}Oₓ, used a combination of both boron and aluminum. Unlike cobalt containing samples, the boron and aluminum promoted samples did not produce any detectable methane at elevated pressure.

An even more significant effect of boron stabilizer was found when processed at a calcination temperature of 700° C. for 1 hour. The Fe₂O₃—Al_{0.40}Cu_{0.10}B_{0.10}Oₓ sample calcined at 700° C. was found to exhibit thermal stability that was better than the commercial iron-chromium catalyst at 400 psi. The thermal stability performance at 400 psi for the commercial Fe/Cr and the new catalyst (Fe₂O₃—Al_{0.40}Cu_{0.10}B_{0.10}Oₓ calcined at 700° C.) are displayed in FIGS. 1 and 2, respectively. The degree of methanation was initially higher for the commercial catalyst at 550° C.; however, methanation at 350° C. for both catalysts was not detectable with the gas chromatograph. The beneficial effect of boron is particularly obvious when comparing FIGS. 2 and 3. FIG. 3 shows the thermal degradation that occurs for the same Fe:Cu:Al ratio as FIG. 2 in the absence of boron. The suppression of thermal degradation by the addition of boron demonstrates that these compositions are a viable replacement for chromium-based high-temperature shift (HTS) catalysts. Previous research has shown that boron addition to conventional Fe/Cr water-gas-shift catalysts poisons the catalytic performance [Rhodes; Catalysis Communications, 3(2002): 381-84]. Based on those previous reports, there would be no motivation to add boron to an Fe-based WGS catalyst. However, based on the disclosed results, with the correct composition and/or processing procedure, we demonstrate that it is possible to use boron as a performance stabilizer without substantially affecting initial catalytic performance. While one skilled in the art would recognize that many possibilities may exist to explain this effect, it is possible that a borate phase may form, and consequently suppresses grain boundary growth and copper and/or iron sintering of the catalyst. The low toxicity and low cost of boron compounds could enable wide scale adoption by catalyst end users and manufacturers. It should also be noted that commercial catalysts with copper suffer from pyrophoricity. The addition of boron and formation of metal borates may also retard flammability/reactivity in ambient oxygen/humidity containing environments. The surface area of samples calcined between 600 and 700° C. are on the order of commercial HTS catalysts.

TABLE 2
WGS testing results for various catalyst compositions tested at 100 psi.

| | | | Surface Area | % CO Conversion at 350° C. | |
|---|---|---|---|---|---|
| Target Composition | Method | Calcination | (m²/g) | Initial | 1 Cycle |
| commercial Fe/Cr | NA | NA | ~55 | 66 | 60 |
| Fe₂O₃—Al_{0.2}Cu_{0.1}Oₓ | co-precip | 500° C./1 hour | 78 | 27 | 7 |
| Fe₂O₃—Al_{0.2}Cu_{0.1}Co_{0.1}Oₓ | co-precip | 500° C./1 hour | 118 | 69 | 44 |
| Fe₂O₃—Al_{0.4}Cu_{0.1}Oₓ | co-precip | 500° C./1 hour | 163 | 66 | 34 |
| Fe₂O₃—Al_{0.40}Cu_{0.05}Oₓ | co-precip | 500° C./1 hour | 166 | 73 | 33 |
| Fe₂O₃—Ce_{0.2}Cu_{0.1}Oₓ | co-precip | 500° C./1 hour | 129 | 50 | 28 |
| Fe₂O₃—Al_{0.4}Cu_{0.1}Co_{0.05}Oₓ | co-precip | 500° C./1 hour | 174 | 63 | 50 |
| Fe₂O₃—Al_{0.8}Cu_{0.1}Oₓ | co-precip | 500° C./1 hour | 177 | 33 | 13 |
| Fe₂O₃—Al_{0.4}Cu_{0.10}Co_{0.01}Oₓ | co-precip | 500° C./1 hour | 182 | 80 | 49 |
| Fe₂O₃—Al_{0.8}Cu_{0.10}Co_{0.01}Oₓ | co-precip | 500° C./1 hour | 205 | 74 | 20 |
| Fe₂O₃—Mg_{0.4}Cu_{0.10}Oₓ | co-precip | 500° C./1 hour | 135 | 69 | 18 |
| Fe₂O₃—Al_{0.4}Cu_{0.10}B_{0.10}Oₓ | co-precip | 500° C./1 hour | 183 | 83 | 59 |
| Fe₂O₃—B_{0.40}Cu_{0.10}Oₓ | co-precip | 500° C./1 hour | 46 | 64 | 25 |
| Fe₂O₃—Al_{0.40}Cu_{0.075}B_{0.10}Oₓ | co-precip | 500° C./1 hour | 182 | 71 | 52 |
| Fe₂O₃—Al_{0.4}Cu_{0.075}B_{0.05}Oₓ | co-precip | 500° C./1 hour | 186 | 69 | 32 |
| Fe₂O₃—Al_{0.4}Cu_{0.075}B_{0.20}Oₓ | co-precip | 500° C./1 hour | 182 | 77 | 36 |
| Fe₂O₃—Al_{0.4}Cu_{0.10}B_{0.01}Oₓ | IW | 700° C./1 hour | 31 | 61 | — |

TABLE 3
WGS testing results for various catalyst compositions tested at 400 psi.

| | | | Surface | % CO Conversion | | |
|---|---|---|---|---|---|---|
| | | | Area | at 350° C. | | |
| Target Composition | Method | Calcination | (m²/g) | Initial | 1 Cycle | 2 Cycles |
| Commercial Fe/Cr | — | — | ~55 | 75 | 73 | 70 |
| Fe₂O₃—Al_{0.40}Cu_{0.075}B_{0.10}Oₓ | co-precip | 500° C./1 hour | 182 | 76 | 58 | 53 |
| Fe₂O₃—Al_{0.40}Cu_{0.10}B_{0.10}Oₓ | co-precip | 500° C./1 hour | 188 | 74 | — | — |
| Fe₂O₃—Al_{0.40}Cu_{0.10}B_{0.10}Oₓ | co-precip | 700° C./1 hour | 32 | 72 | 70 | 70 |
| Fe₂O₃—Al_{0.40}Cu_{0.10}Oₓ | co-precip | 700° C./1 hour | 43 | 80 | 51 | — |

The Fe₂O₃—Al_{0.40}Cu_{0.10}B_{0.10}Oₓ catalyst was further characterized by X-ray Photoelectron Spectroscopy (XPS) and Inductively Coupled Plasma Atomic Emission spectroscopy (ICP-AES). Three variations of the catalyst were examined by XPS: calcination at 500° C., calcination at 700° C., and post-WGS testing (400 psi) of the sample calcined at 700° C. XPS is a surface-sensitive technique, so the analysis determines the relative ratio of elements on the surface (typically the first few nanometers). As seen in Table 4, the samples all contained Cu, Fe, B, and Al on the surface. The surface ratios do not match the target composition; therefore, it is likely that the surface of the catalyst is enriched with some species, such as Cu, B, and Al. ICP-AES analysis was performed on the sample calcined at 700° C. to determine the bulk composition of the catalyst. The ratios of Fe:Cu and Fe:Al in the catalyst were similar to the target composition used in the precipitation process. The boron composition was lower than the target composition, and much lower than the surface composition. Based on this result, only a small fraction of boron is precipitating out with the catalyst, and the boron that is in the catalyst is concentrated at the surface. It is possible that the boron concentrates at grain boundaries of Fe, Al, or Cu. Again, without any limitation as to theoretical basis, if so, such a Fe—B, Al—B, or Cu—B phase could prevent the catalyst from sintering and deactivating. One would also expect such a phase to allow the catalyst to maintain a high surface area after calcination.

Further characterization of the catalyst after testing was conducted with X-Ray Diffraction (XRD). XRD can be used to determine the crystallinity of substances. FIG. 4 shows the XRD pattern for the Fe₂O₃—Al_{0.40}Cu_{0.10}B_{0.10}Oₓ catalyst after calcination at 700° C. and durability testing at 400° C. The XRD pattern shows that the catalyst predominantly has a magnetite crystal structure. After calcination, one would expect the material to have a hematite structure, so this magnetite phase likely forms once the catalyst is reduced. Since the WGS reaction is believed to proceed through a redox mechanism, it is likely that multiple oxidation states and crystal structures could be present on the surface during operation. The significance of the XRD pattern is that separate crystal structures for aluminum, copper, or boron phases are not observed. This suggests that the heteroatoms are, for the most part, intimately mixed and contained within the same crystal structure as iron. One could also say that the heteroatoms form a solid solution with the iron oxide.

TABLE 4
XPS analysis of catalyst samples

| | Relative Surface Composition from XPS | | | |
|---|---|---|---|---|
| Sample | Cu | Fe | B | Al |
| Fe₂O₃—Al_{0.40}Cu_{0.10}B_{0.10}Oₓ | 6% | 54% | 1.5% | 38% |
| (calcined at 500° C.) | | | | |
| Fe₂O₃—Al_{0.40}Cu_{0.10}B_{0.10}Oₓ | 13% | 27% | 1.2% | 59% |
| (calcined at 700° C.) | | | | |
| Fe₂O₃—Al_{0.40}Cu_{0.10}B_{0.10}Oₓ | 17% | 32% | 1.4% | 49% |
| (calcined at 700° C., | | | | |
| post WGS testing) | | | | |

TABLE 5
ICP-AES Analysis of catalyst sample

| | Relative Composition from ICP-AES | | | |
|---|---|---|---|---|
| Sample | Cu | Fe | B | Al |
| Fe₂O₃—Al_{0.40}Cu_{0.10}B_{0.10}Oₓ | 4.0% | 85.5% | 0.1% | 7.6% |
| (calcined at 700° C.) | | | | |

### Example 1

### Hot Base Co-Precipitation

To prepare the iron-aluminum-copper-boron catalyst (Fe₂O₃—Al_{0.40}Cu_{0.10}B_{0.10}Oₓa co-precipitation method was used. Metal nitrate salts and boric acid were dissolved in 250 mL of distilled water, specifically Fe (III) nitrate nonahydrate (16.165 grams), Al (III) nitrate nonahydrate (3.010 grams), Cu(II) nitrate hydrate-2.5-H₂O (0.470 grams), along with 0.130 grams of boric acid. Next, 600 mL of 0.5 M NaOH was prepared and heated to 70° C. The acidic salt solution was rapidly mixed with the heated base, resulting in the formation of a solid precipitate. After precipitation, the mixture is stirred for 2 hours, and the precipitate is aged for 70 hours in the mother liquor. Next, while stirring the mixture, an additional 0.5 M NaOH is added dropwise until the pH of the mixture is 10, and the mixture is aged another 2 hours. Finally, the solid precipitate is washed multiple times, using filtration or centrifuge methods, in distilled water to remove most of the dissolved ions, and dried at 70° C., and subsequently calcined in air for 1 hour at 500° C. to form the catalyst.

### Example 2

### Incipient Wetness of Boron

To prepare the iron-aluminum-copper-boron catalyst (Fe₂O₃—Al_{0.40}Cu_{0.10}B_{0.01}Oₓ—IW) a co-precipitation method combined with incipient wetness was used. Metal nitrate salts were dissolved in 250 mL of distilled water, specifically Fe (III) nitrate nonahydrate (16.165 grams), Al (III) nitrate nonahydrate (3.010 grams), and Cu(II) nitrate hydrate-2.5-H₂O (0.470 grams). Next, 600 mL of 0.5 M NaOH was prepared and heated to 70° C. The acidic salt solution was rapidly mixed with the heated base, resulting in the formation of a solid precipitate. After precipitation, the mixture is stirred for 2 hours. Next, while stirring the mixture, an additional 0.5 M NaOH is added dropwise until the pH of the mixture is 10, and the mixture is aged another 2 hours. Finally, the solid precipitate is washed multiple times, using filtration or centrifuge methods, in distilled water to remove most of the dissolved ions, and dried at 70° C. Next, 0.003 to 0.120 g, preferably 0.014 g, of boric acid (or other soluble boron precursor) is dissolved in 5 mL of distilled water. The boric acid solution is then added dropwise to the dried precipitate while mixing. The wetted precipitate is then dried again at 70° C. Finally, the sample is calcined at 300 to 700° C. to form the catalyst.

What is claimed, then, are various embodiments of a chromium-free water-gas catalyst including iron and boron, and the iron may include a plurality of iron oxides. In some embodiments, the catalyst may include aluminum, while in others in may include copper, or aluminum and copper. The catalyst may be prepared, by way of example only and not limitation, to have a surface area of at least 30 m^{2/}g, at least 60 m^{2/}g, a surface area of at least 90 m^{2/}g, and a surface area of at least 120 m^{2/}g in various embodiments.

Boron may be present in differing amounts on the surface of the catalyst. In one embodiment, the catalyst may a particle surface composition by mole that is greater than 0.5% boron and less than 3.0% boron, while in other embodiments, the catalyst may have a particle surface composition by mole that is greater than 0.5% boron and less than 2% boron. Similarly, in other embodiments, the boron may be present in different total compositions within the catalyst. In one embodiment, the catalyst may have a total composition by mass of greater than 0.001% boron and less than or equal to 2% boron, while in another, the catalyst may have a total composition of greater than 0.01% boron and less than or equal to 0.5% boron.

In another series of embodiments, a chromium-free water-gas catalyst may include boron and copper, and these embodiments may further include aluminum or iron. In one particular embodiment, the catalyst includes all four; iron, boron, aluminum, and copper.

One skilled in the art will perceive a process for producing a catalyst having improved thermal stability, that includes the steps of mixing a catalyst precursor and a source of boron to form a first mixture and then calcining the first mixture at a temperature equal to or greater that 300° C. to form the catalyst. In some distinct embodiments, the boron source may include a source of boron consisting of boric acid, alkali borate salts, boron nitride, alkali borohydrides, ammonia borane, organoboron compounds, iron boride, aluminum boride, copper boride, iron borate, aluminum borate, copper borate, and mixtures thereof. In some embodiments, the catalyst precursor may include a source of boron having a weight relative to the catalyst equal to or greater than 0.01% and equal to or less than 0.5%. The catalyst precursors, in various embodiments, may include a hydroxide of iron, a hydroxide of copper, a hydroxide of aluminum, mixtures thereof, a carbonate of iron, a carbonate of copper, a carbonate of aluminum, mixtures thereof, and mixtures of a hydroxide of iron, a hydroxide of copper, a hydroxide of aluminum, mixtures thereof, a carbonate of iron, a carbonate of copper, and a carbonate of aluminum, with a source of boron. One skilled in the art will be able to realize other possible sources of both boron and catalyst precursor.

One skilled in the art will also be able to realize a wide range in temperature for the step of calcining the first mixture of boron and catalyst precursor. In one embodiment, the step of calcining the first mixture may actually include the step of calcining the first mixture at a temperature equal to or greater than 450° C.

We claim:

1. A chromium-free water-gas catalyst comprising:
iron, and
boron.

2. The catalyst according to claim 1, further comprising aluminum.

3. The catalyst according to claim 1, further comprising copper.

4. The catalyst according to claim 2, further comprising copper.

5. The catalyst according to claim 1, comprising a surface area of at least 30 m^{2/}g.

6. The catalyst according to claim 1, comprising a surface area of at least 60 m^{2/}g.

7. The catalyst according to claim 1, comprising a surface area of at least 90 m^{2/}g.

8. The catalyst according to claim 1, comprising a surface area of at least 120 m^{2/}g.

9. The catalyst according to claim 1, wherein the catalyst has a particle surface composition by mole that is greater than 0.5% boron and less than 3.0% boron.

10. The catalyst according to claim 1, wherein the catalyst has a total composition by mass of greater than 0.001% boron and less than or equal to 2% boron.

11. The catalyst according to claim 1, wherein the catalyst has a particle surface composition by mole that is greater than 0.5% boron and less than 2% boron.

12. The catalyst according to claim 1, wherein the catalyst has a total composition of greater than 0.01% boron and less than or equal to 0.5% boron.

13. The catalyst according to claim 1, wherein the iron further comprises a plurality of iron oxides.

14. A chromium-free water-gas catalyst comprising:
boron, and
copper.

15. The catalyst according to claim 14, further comprising aluminum.

16. The catalyst according to claim 14, further comprising iron.

17. A chromium-free water-gas shift catalyst, comprising:
iron;
boron;
aluminum; and
copper.

18. A process for producing a catalyst having improved thermal stability, comprising the steps of:
a. mixing a catalyst precursor and a source of boron to form a first mixture; and
b. calcining the first mixture at a temperature equal to or greater that 300° C. to form the catalyst.

19. The process according to claim 18, wherein the step of mixing a catalyst precursor with a source of boron comprises mixing a catalyst precursor with a source of boron selected from the sources of boron consisting of boric acid, boron oxide, alkali borate salts, boron nitride, alkali to borohydrides, ammonia borane, organoboron compounds, iron boride, aluminum boride, copper boride, iron borate, aluminum borate, copper borate, and mixtures thereof.

20. The process according to claim 18, wherein the step of mixing a catalyst precursor with a source of boron comprises mixing a catalyst precursor with a source of boron having a weight relative to the catalyst equal to or greater than 0.01% and equal to or less than 0.5%.

21. The process according to claim 18, wherein the step of mixing a catalyst precursor with a source of boron comprises mixing a catalyst precursor selected from the group of catalyst precursors consisting of a hydroxide of iron, a hydroxide of copper, a hydroxide of aluminum, mixtures thereof, a carbonate of iron, a carbonate of copper, a carbonate of aluminum, mixtures thereof, and mixtures of a hydroxide of iron, a hydroxide of copper, a hydroxide of aluminum, mixtures thereof, a carbonate of iron, a carbonate of copper, and a carbonate of aluminum, with a source of boron.

22. The process according to claim 18, wherein the step of calcining the first mixture at a temperature equal to or greater that 300° C. further comprises the step of calcining the first mixture at a temperature equal to or greater than 450° C.
